(19) United States
(12) Patent Application Publication
(10) Pub. No.: US 2015/0271352 A1
(43) Pub. Date: Sep. 24, 2015

(54) IMAGE FORMING APPARATUS

(71) Applicant: Oki Data Corporation, Tokyo (JP)

(72) Inventor: Takafumi FUKUDA, Tokyo (JP)

(73) Assignee: OKI DATA CORPORATION, Tokyo (JP)

(21) Appl. No.: 14/640,819

(22) Filed: Mar. 6, 2015

(30) Foreign Application Priority Data
Mar. 24, 2014 (JP) 2014-060116

(51) Int. Cl. H04N 1/00; G06K 15/00; G06F 3/12

(52) U.S. Cl. CPC H04N 1/00854; G06F 3/1222; G06F 3/1238; G06K 15/4095; H04N 1/00339; H04N 1/00352; H04N 2201/0094; H04N 2201/0082

(57) ABSTRACT

An image forming apparatus includes a memory, a function executing unit, an acquiring unit, an authentication unit and an operation unit. The memory stores first authentication information. The function executing unit executes processing. The acquiring unit acquires second authentication information. The authentication unit executes authentication of an user by using the first authentication information and the second authentication information. The operation unit accepts operation input. When the authentication succeeds and first condition is satisfied, the function executing unit executes the processing with the operation unit restricting the operation input.

### CROSS REFERENCE TO RELATED APPLICATIONS

This application claims priority based on 35 USC 119 from prior Japanese Patent Application No. 2014-060116 filed on Mar. 24, 2014, entitled “IMAGE FORMING APPARATUS”, the entire contents which are incorporated herein by reference.

### BACKGROUND OF THE INVENTION

1. Field of the Invention

This application relates to an image forming apparatus.

2. Description of Related Art

There is an image forming apparatus which needs an authentication to use the image forming apparatus conventionally. In such the image forming apparatus, when a user forgets logout operation and the image forming apparatus is left as the login state, personal information may leak out by spoofing attacks. To evade such the leak, an image forming apparatus executes a logout processing when the image forming apparatus completes a process (see, for example, Japanese Laid-open Patent Publication No. 2010-136440).

However, in such conventional techniques, a convenience is low.

### SUMMARY OF THE INVENTION

According to an aspect of the disclosed invention, an image forming apparatus includes a memory, a function executing unit, an acquiring unit, an authentication unit and an operation unit. The memory stores first authentication information. The function executing unit executes processing. The acquiring unit acquires second authentication information. The authentication unit executes authentication of an user by using the first authentication information and the second authentication information. The operation unit accepts operation input. When the authentication succeeds and first condition is satisfied, the function executing unit executes the processing with the operation unit restricting the operation input.

According to another aspect of the disclosed invention, an image forming apparatus includes a memory, a job memory, a function executing unit, an acquiring unit, an authentication unit and a control unit. The memory stores first authentication information. The job memory stores a job about processing to execute. The function executing unit executes the processing based on the job. The acquiring unit acquires second authentication information. The authentication unit executes authentication of an user by using the first authentication information and the second authentication information. The control unit executes first processing when the authentication succeeds and the job corresponding to the user is stored in the job memory, and to execute second processing when the authentication succeeds and the job corresponding to the user isn't stored in the job memory.

According to this invention, the convenience improves.

### BRIEF DESCRIPTION OF THE DRAWINGS

In the attached drawings:

FIG. 1 is a schematic view showing a printing processing system according to a first embodiment;

FIG. 2 is a block diagram showing a configuration of an image forming apparatus according to the first embodiment;

FIG. 3 is schematic view of an operation panel according to the first embodiment when the image forming apparatus is in logout state;

FIG. 4 is flowcharts showing processing of an authentication unit according to the first embodiment;

FIG. 5 is schematic view of the operation panel according to the first embodiment when an error message of not having authority is displayed;

FIG. 6 is schematic view of the operation panel according to the first embodiment when an error message of being executing an authentication job is displayed;

FIG. 7 is schematic view of the operation panel according to the first embodiment when a panel lock is released;

FIG. 8 is flowcharts showing processing of an authentication job processing unit according to the first embodiment;

FIG. 9 is schematic view of operation panel during executing the job according to the first embodiment.

### DETAILED DESCRIPTION OF EMBODIMENTS

Hereinafter, preferred embodiments of the invention will be described with reference to the attached drawings.

### 1. First Embodiment

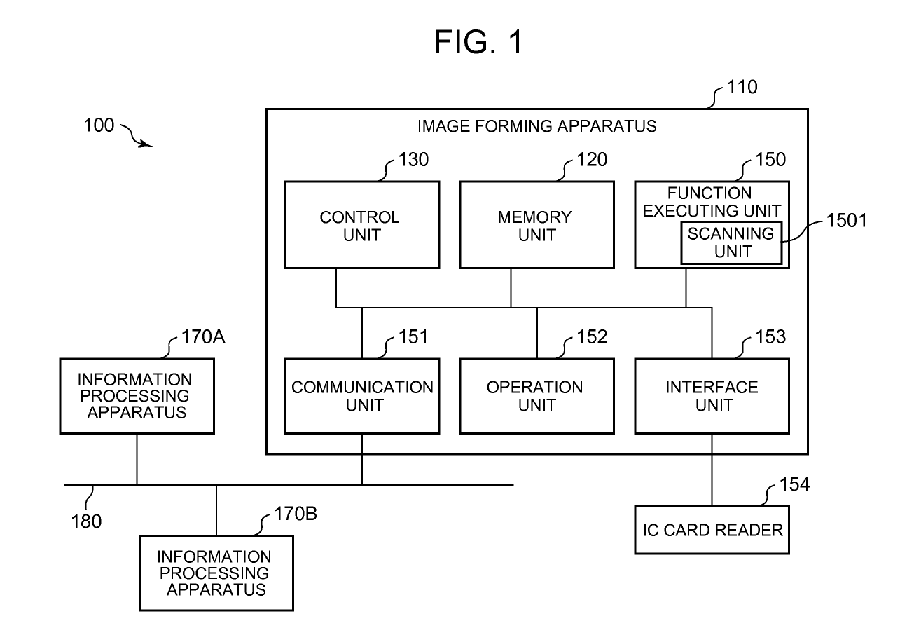

FIG. 1 shows a whole configuration of a printing processing system 100 which is an image forming system related with the first embodiment schematically.

The printing processing system 100 may include an image forming apparatus 110, an information processing apparatus 170A and an information processing apparatus 170B. When it is not necessary to distinguish the information processing apparatus 170B from the information processing apparatus 170A, the information processing apparatus 170A and 170B are named the information processing apparatus 170 each. The image forming apparatus 110 and the information processing apparatus 170 are communicably connected to one another through an LAN 180. In FIG. 1, the number of the information processing apparatus 170 is two. However, the number of the information processing apparatus 170 is not limited in particular. An IC card reader 154 as a personal information input part is connected to the image forming apparatus 110.

As shown in FIG. 1, the image forming apparatus 110 may include a memory unit 120, a control unit 130, a function executing unit 150, a communication unit 151, an operation unit 152 and an interface unit 153.

The memory unit 120 stores information required for processing at the image forming apparatus 110. For example, the memory unit 120 stores first authentication information for executing authentication of a user of the image forming apparatus 110.

The control unit 130 controls each unit of the image forming apparatus 110. The control unit 130 realizes a function at the image forming apparatus 110. For example, the control unit 130 acquires second authentication information from the user of the image forming apparatus 110. The control unit 130 executes the authentication of the user by using the first authentication information that is stored in the memory unit 120 and the second authentication information. When the function executing unit 150 is in condition to be able to execute processing, the control unit 130 controls the function executing unit 150 to execute the processing according to the user with the operation unit 152 restricting operation input. When a job that indicates a content of the processing is stored in the memory unit 120, the control unit 130 may determine that the function executing unit 150 is in condition to be able to execute processing. When the function executing unit 150 includes a scanning unit 1501 that scans an image of an original document, the control unit 130 may determine that the function executing unit 150 is in condition to be able to execute processing when the original document is on the scanning unit 1501.

The function executing unit 150 executes the processing corresponding to the function that the image forming apparatus 110 has. For example, the memory unit 120 stores an authentication job for executing image forming processing. The executing unit 150 executes image forming processing based on the stored authentication job.

The communication unit 151 communicates with the information processing apparatus 170 through the LAN 180.

The operation unit 152 functions as an input unit that accepts the operation input. The operation unit 152 functions as a display unit that displays a screen.

The interface unit 153 executes communication with IC card reader 154. The interface unit 153 may be USB interface.

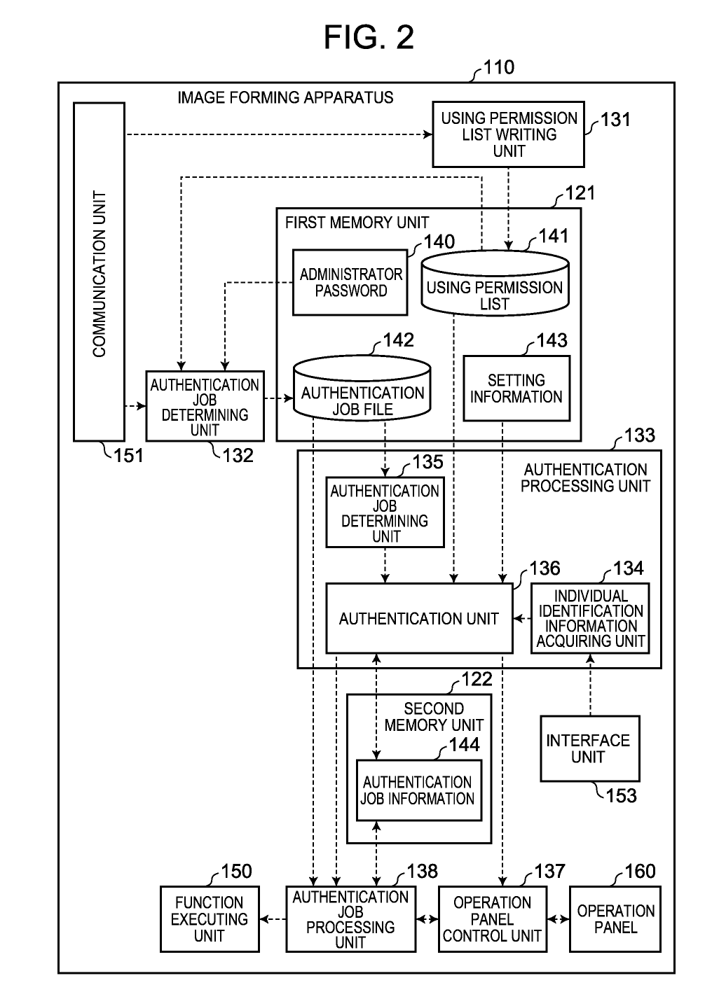

FIG. 2 shows a block diagram showing a configuration of the image forming apparatus 110 schematically.

The image forming apparatus 110 may include a first memory unit 121, a second memory unit 122, an using permission list writing unit 131, an authentication job receiving unit 132, an authentication processing unit 133, an operation panel control unit 137, an authentication job processing unit 138, the function executing unit 150, the communication unit 151, an operation panel 160 and the interface unit 153. The memory unit 120 in FIG. 1 corresponds to the first memory unit 121 and the second memory unit 122. The control unit 130 in FIG. 1 corresponds to the using permission list writing unit 131, the authentication job receiving unit 132, the authentication processing unit 133, the operation panel control unit 137 and the authentication job processing unit 138. The operation unit 152 in FIG. 1 corresponds to the operation panel 160.

The first memory unit 121 stores an administrator password 140, a using permission list 141, an authentication job file 142 and setting information 143.

The administrator password 140 is administrator authentication information for executing authentication of an administrator of the image forming apparatus 110.

The using permission list 141 is user authentication information for executing authentication of a user of the image forming apparatus 110. The using permission list 141 may include individual identification information for identifying the user having authority for using the image forming apparatus 110. The individual identification information is first authentication information.

The authentication job file 142 is a file of an authentication job executed in the image forming apparatus 110. The authentication job includes authentication job identification information indicating the authentication job, individual identification information indicating a user who generates the authentication job and job data that the image forming apparatus 110 executes image forming processing based on. The job data is printing data.

The setting information 143 is information for identifying a setting that is referred to when the image forming apparatus 110 executes the authentication job. The setting information 143 includes other function using permission setting information. The other function using permission setting information indicates whether the image forming apparatus 110 can execute other function when the image forming apparatus 110 is executing the authentication job.

The second memory unit 122 stores authentication job information 144.

The second memory unit 122 stores the authentication job information 144 as a memory table. When the authentication job is executed, a record is added to the authentication job information 144. When the authentication job is finished, the record is deleted from the authentication job information 144. The record includes executing job identification information for identifying the executed authentication job and executing status information indicating status of the processing according to the authentication job. The executing job identification information may include file name of the authentication job file 142.

The using permission list writing unit 131 acquires a list that includes individual identification information for identifying a user having an authority of using the image forming apparatus 110, from the communication unit 151. The using permission list writing unit 131 writes the list as the using permission list 141 in the first memory unit 121.

The authentication job receiving unit 132 acquires a job from the communication unit 151. The authentication job receiving unit 132 determines whether the acquired job is the authentication job. When the acquired job includes the authentication job identification information, the authentication job receiving unit 132 determines that the acquired job is the authentication job. When the acquired job is the authentication job, the authentication job receiving unit 132 determines whether the individual identification information included the authentication job is registered in the using permission list 141 stored in the first memory unit 121. When the individual identification information is registered in the using permission list 141, the authentication job receiving unit 132 writes the authentication job as the authentication job file 142 in the first memory unit 121. The authentication job receiving unit 132 adds the file name to each authentication job file 142.

The authentication processing unit 133 acquires the second authentication information from the user of the image forming apparatus 110. The authentication processing unit 133 executes the authentication of the user. The authentication processing unit 133 transmits instruction to the operation panel control unit 137 and the authentication job processing unit 138 according to a result of the authentication. The authentication processing unit 133 may include an individual identification information acquiring unit 134, an authentication job determining unit 135 and an authentication unit 136.

The individual identification information acquiring unit 134 acquires individual identification information of the user of the image forming apparatus 110. The individual identification information is second authentication information. The individual identification information acquiring unit 134 controls the IC card reader 154 connected to the interface unit 153. When the IC card reader 154 detects an IC card (smart card, card), namely, when the individual identification information acquiring unit 134 detects that the IC card reader 154 can read the IC card, the individual identification information acquiring unit 134 acquires the individual identification information from the IC card. The individual identification information acquiring unit 134 transmits the individual identification information to the authentication unit 136.

The authentication job determining unit 135 determines whether the authentication job file 142 including the individual identification information specified by the authentication unit 136 is stored in the first memory unit 121. When the authentication job file 142 including the individual identification information specified by the authentication unit 136 is stored in the first memory unit 121, the authentication job determining unit 135 transmits the file name of the authentication job file 142 as information of the authentication job to the authentication unit 136.

The authentication unit 136 executes the authentication of the user of the image forming apparatus 110. When information corresponding to the individual identification information transmitted from the individual identification information acquiring unit 134 is registered in the using permission list 141 stored in the first memory unit 121, the authentication unit 136 determines that the authentication of the user succeeds.

When the authentication succeeds, the authentication unit 136 determines whether the function executing unit 150 is executing the authentication job based on the authentication job file 142. For example, when the authentication job information 144 stored in the second memory unit 122 includes the record, the authentication unit 136 determines that the function executing unit 150 is executing the authentication job.

When the function executing unit 150 isn't executing the authentication job, the authentication unit 136 determines whether predetermined first condition is satisfied. The first condition is that the authentication job of which the user who was authenticated has the execution authority is stored in the first memory unit 121. When the first condition is satisfied, the authentication unit 136 transmits the instruction indicating that the function executing unit 150 executes the processing based on the authentication job, to the authentication job processing unit 138. On the other hand, when the first condition isn't satisfied, the authentication unit 136 makes the image forming apparatus 110 shift from a state of the logout to a state of the login. The authentication unit 136 controls the operation panel control unit 137 to release restriction of the operation input to the operation panel 160. Before the authentication of the user succeeds, the operation input to the operation panel 160 is restricted so that the user can't input the instruction of executing the function to the image forming apparatus 110. When the restriction is released, the user can input the instruction of executing the function to the image forming apparatus 110.

When the function executing unit 150 is executing the authentication job, the authentication unit 136 determines whether predetermined second condition is satisfied. The second condition is that the setting information 143 indicates that the image forming apparatus 110 can execute other functions while the image forming apparatus 110 is executing the authentication job, and the executed authentication job related to the user who was authenticated. When the second condition is satisfied, the authentication unit 136 makes the image forming apparatus 110 shift from the state of the logout to the state of the login. Then the authentication unit 136 controls the operation panel control unit 137 to release restriction of the operation input to the operation panel 160. On the other hand, when the second condition isn't satisfied, the authentication unit 136 maintains the logout state of the image forming apparatus 110. Then the authentication unit 136 controls the operation panel control unit 137 to maintain the restriction of the operation input to the operation panel 160.

When the authentication fails, the authentication unit 136 maintains the logout state of the image forming apparatus 110. Then the authentication unit 136 controls the operation panel control unit 137 to maintain the restriction of the operation input to the operation panel 160.

The login state of the image forming apparatus 110 is state in which the user can make the image forming apparatus 110 execute the function based on the authority of the user. Therefore, in the login state, the authentication unit 136 controls the operation panel control unit 137 to release the restriction of the operation input to the operation panel 160. Therefore the user can make the image forming apparatus 110 execute the function. The restriction may be lock of the operation panel 160.

On the other hand, The logout state of the image forming apparatus 110 is state that the user can't make the image forming apparatus 110 execute the function. Therefore, in the logout state, the authentication unit 136 controls the operation panel control unit 137 to restrict the operation input to the operation panel 160. Therefore the user can't make the image forming apparatus 110 execute the function. However, even if the operation panel 160 is restricted, the user can input the instruction for the ON/OFF of a power supply and the authentication of the user.

The function of the image forming apparatus 110 may include the function for forming image at least. The function for forming image is the printing function. The function of the image forming apparatus 110 may include a copy function, a scanning function and a facsimile function. The scanning function is the function in which the image forming apparatus 110 scans the original document to generate image data, then the image forming apparatus 110 sends the generated image data by email. The facsimile function is the function that the image forming apparatus 110 scans the original document, then the image forming apparatus 110 sends the image data of the original document by FAX, the image forming apparatus 110 acquires the image data by FAX and the image forming apparatus 110 prints the acquired image data.

The operation panel control unit 137 controls the operation panel 160. When the image forming apparatus 110 is in the logout state, the operation panel control unit 137 locks the operation panel 160 so that the operation panel 160 doesn't accept the operation input from the user. On the other hand, when the image forming apparatus 110 is in the login state, the operation panel control unit 137 releases the lock of the operation panel 160 so that the operation panel 160 accepts the operation input from the user. The operation panel control unit 137 controls the operation panel 160 to display various screens according to the instruction from the authentication unit 136. The operation panel control unit 137 transmits various information and various instructions to each unit based on the operation input to the operation panel 160.

The authentication job processing unit 138 controls the function executing unit 150 to execute processing based on the authentication job file 142. The authentication job processing unit 138 acquires the authentication job file 142 indicated by the authentication job information 144 stored the second memory unit 122, from the first memory unit 121. The authentication job processing unit 138 controls the function executing unit 150 to execute the process based on the acquired authentication job file 142. After The function executing unit 150 completed the processing, the authentication job processing unit 138 deletes the record corresponding to the acquired authentication job file 142 from the authentication job information 144 stored the second memory unit 122 and the authentication job file 142 from the first memory unit 121.

The image forming apparatus 110 requires a login authentication to execute the function. The image forming apparatus 110 stores the acquired authentication job without executing the acquired authentication job immediately. After the login authentication is succeeded, the image forming apparatus 110 executes the acquired authentication job. Therefore, a security is enhanced. When the login authentication is succeeded, if the authentication job related to the user who was authenticated is stored, the image forming apparatus 110 doesn't shift from the logout state to the login state and maintains the logout state. Then the image forming apparatus 110 executes only the stored authentication job. On the other hand, when the login authentication is succeeded, if the stored authentication job doesn't exist, the image forming apparatus shifts to login state from logout state.

At first, a list of individual identification information about the user who has the authority for using the image forming apparatus 110 is registered with the image forming apparatus 110 beforehand.

For example, the information processing apparatus 170 transmits the list of individual identification information and an administrator password of the image forming apparatus 110 to image forming apparatus 110 based on an instruction from an administrator who activates a utility program.

In the image forming apparatus 110 that acquires the list of individual identification information and the administrator password, the communication unit 151 transmits the list and the administrator password to the using permission list writing unit 131. When the transmitted administrator password corresponds to the administrator password 140 stored in the first memory unit 121, the using permission list writing unit 131 writes the transmitted list as the using permission list 141 in the first memory unit 121.

It is explanation of storing the authentication job transmitted from the information processing apparatus 170 as follows.

When the user operates the information processing apparatus 170 for executing printing processing at the image forming apparatus 110, the information processing apparatus 170 generates the authentication job including the individual identification information. Then the information processing apparatus 170 transmits the authentication job to the image forming apparatus 110. Because the authentication job includes the individual identification information, it is desirable to encrypt the authentication job. The individual identification information may be login ID of the information processing apparatus 170 or an employee number that was read from the IC card such as an employee ID card. The information processing apparatus 170 may read the employee number from the IC card through an IC card reader connected to the information processing apparatus 170.

In the image forming apparatus 110 that acquired the authentication job, the authentication job is transmitted from the communication unit 151 to the authentication job receiving unit 132. The authentication job receiving unit 132 determines whether the received authentication job includes the authentication job identification information.

Then the authentication job receiving unit 132 determines whether the individual identification information included the received authentication job exists in the using permission list 141 stored the first memory unit 121. When the received authentication job doesn't include the individual identification information or the individual identification information included the received authentication job doesn't exist in the using permission list 141, the authentication job receiving unit 132 discards the received authentication job without writing the received authentication job. On the other hand, when the received authentication job includes the individual identification information and the individual identification information included in the received authentication job exists in the using permission list 141, the authentication job receiving unit 132 writes the received authentication job as the authentication job file 142 in the first memory unit 121. The one authentication job file 142 corresponds to the one authentication job.

It is explanation of the processing of the image forming apparatus 110 in the logout state as follows.

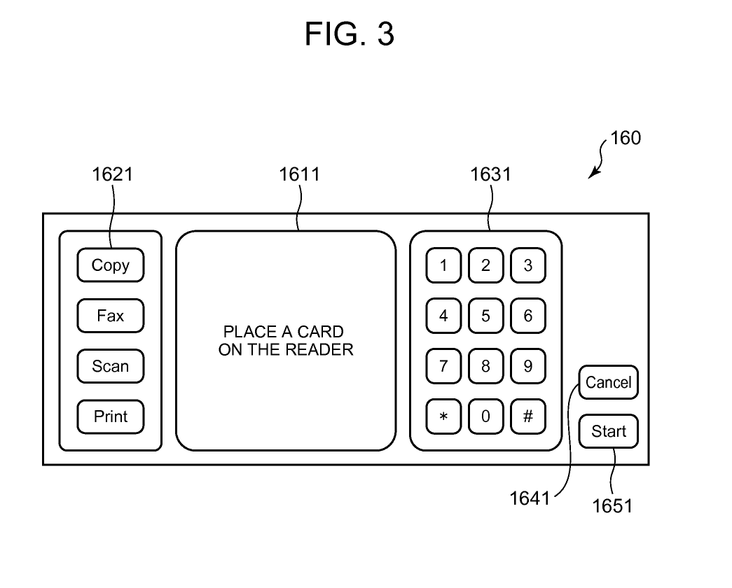

FIG. 3 shows a screen of the operation panel 160 when the image forming apparatus 110 is in the logout state.

The operation panel 160 includes a panel display unit 1611, a function selecting key 1621, a ten key 1631, a cancel key 1641 and a start key 1651.

When the image forming apparatus 110 is in the logout state, the operation panel 160 is locked. For example, as shown FIG. 3, a message “Place a Card on the Reader” is displayed. Even if the function selecting key 1621, the ten key 1631, the cancel key 1641 or the start key 1651 is pushed by the user, the image forming apparatus 110 does not reply to pushing these key. If the IC card is held up on the IC card reader 154 when the image forming apparatus 110 is in the logout state, the individual identification information acquiring unit 134 reads the individual identification information from the IC card through the interface unit 153. Then the individual identification information acquiring unit 134 transmits the read individual identification information to the authentication unit 136.

It is explanation of the processing on the authentication unit 136 as follows.

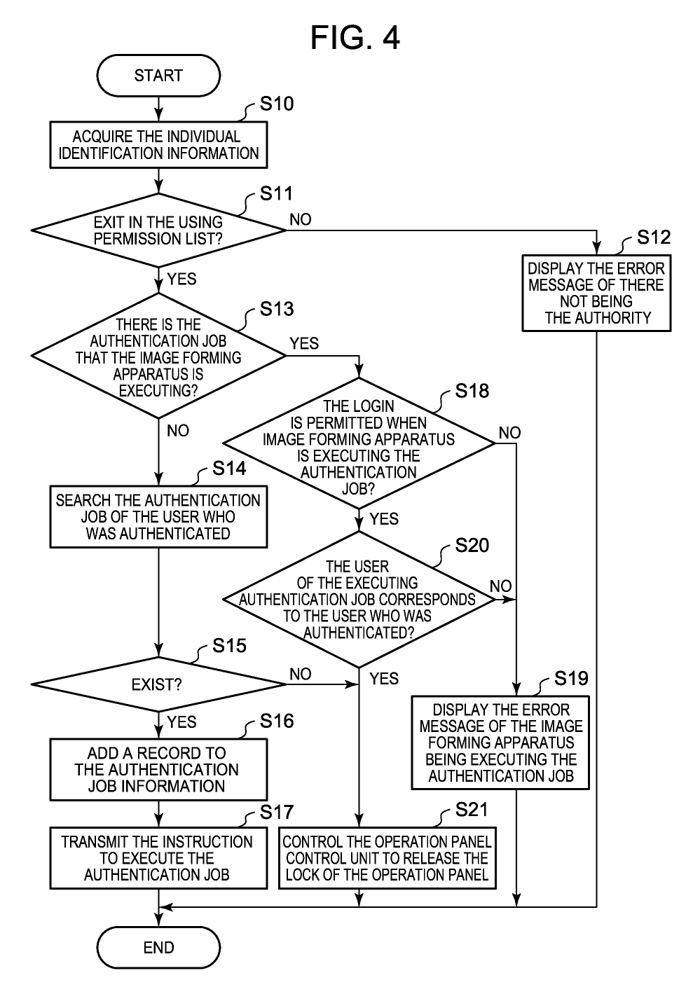

FIG. 4 is a flowchart that shows processing on the authentication unit 136.

The image forming apparatus 110 is in the state of logout. The operation panel control unit 160 restricts the operation input to the operation panel 160. Namely, the operation panel 160 is locked.

At first, the authentication unit 136 acquires the individual identification information from the individual identification information acquiring unit 134 (step S10).

Next, the authentication unit 136 determines whether the information corresponding to the acquired individual identification information exists in the using permission list 141 stored in the first memory unit 121 (step S11). When the information doesn't exist (step S11; NO), the authentication unit 136 moves the process to step S12. On the other hand, when the information exists (step S11; YES), the authentication unit 136 moves the process to step S13.

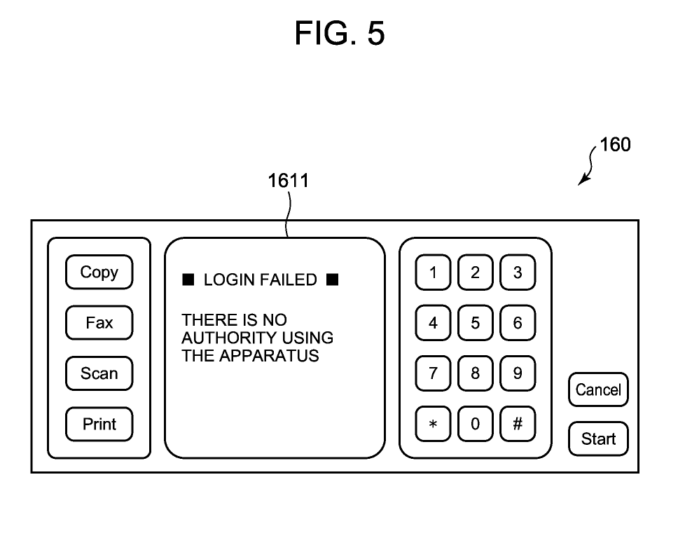

In step S12, the authentication unit 136 controls the operation panel control unit 137 to display an error message of there not being the authority on the operation panel 160. FIG. 5 shows a screen of the operation panel 160 when the error message is displayed. As shown FIG. 5, the message “Login Failed. There is No Authority Using the Apparatus” is displayed on the panel display unit 1611.

In step S13, the authentication unit 136 determines whether there is the authentication job that the image forming apparatus 110 is executing. When the record corresponding to the authentication job is stored in the authentication job information 144 stored in the second memory unit 122, the authentication unit 136 determines that there is the authentication job that the image forming apparatus 110 is executing.

When there isn't the authentication job that the image forming apparatus 110 is executing (step S13; NO), the authentication unit 136 moves the process to step S14. When there is the authentication job that the image forming apparatus 110 is executing (step S13; YES), the authentication unit 136 moves the process to step S18.

In step S14, the authentication unit 136 controls the authentication job determining unit 135 to search the authentication job file 142 corresponding to the authentication job generated by the instruction of the user who was authenticated, in the first memory unit 121. Specifically, the authentication unit 136 transmits the individual identification information transmitted from the individual identification information acquiring unit 134 to the authentication job determining unit 135. Then the authentication unit 136 controls the authentication job determining unit 135 to search the authentication job file 142 that includes information corresponding to the individual identification information.

When such the authentication job file 142 exists in the first memory unit 121 (step S15; YES), the authentication job determining unit 135 reads the authentication job identification information from the searched authentication job file 142. The authentication job determining unit 135 transmits the read authentication job identification information to the authentication unit 136. Then the authentication unit 136 moves the process to step S16.

When such the authentication job file 142 doesn't exist in the first memory unit 121 (step S15; NO), the authentication unit 136 moves the process to step S21.

In step S16, the authentication unit 136 adds a new record corresponding to the transmitted authentication job identification information to the authentication job information 144 stored the second memory unit 122. Namely, the authentication unit 136 writes the authentication job identification information transmitted from the authentication job determining unit 135 to the second memory unit 122.

The authentication unit 136 transmits the instruction for executing the authentication job to the authentication job processing unit 138, without transmitting the instruction for releasing the lock of the operation panel 160 to the operation panel control unit 137 (step S17). Then authentication unit 136 completes the process. As a result, the authentication job corresponding to the IC card is executed with the image forming apparatus 110 maintaining the logout state, only by the user holding up the IC card.

On the other hand, in step S13, when there is the authentication job that the image forming apparatus 110 is executing (step S13; YES), the authentication unit 136 moves the process to step S18.

In step S18, the authentication unit 136 determines whether the login is permitted when the image forming apparatus 110 is executing the authentication job based on the setting information 143 stored in the first memory unit 121. When the login isn't permitted (step S18; NO), the authentication unit 136 moves the process to step S19. When the login is permitted (step S18; YES), the authentication unit 136 moves the process to step S20.

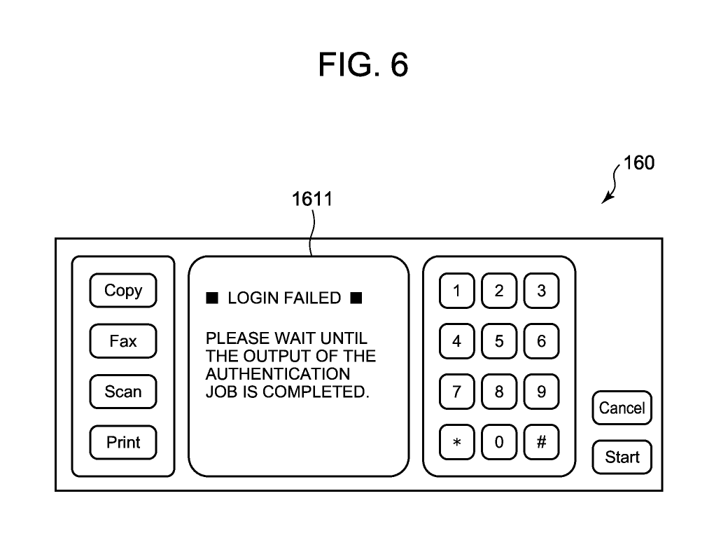

In step S19, the authentication unit 136 controls the operation panel control unit 137 to display an error message of the image forming apparatus 110 being executing the authentication job on the operation panel 160. FIG. 6 shows a screen of the operation panel 160 when the error message is displayed. As shown FIG. 6, the message “Login Failed. Please wait until the output of the Authentication job is completed.” is displayed on the panel display unit 1611.

In step S20, the authentication unit 136 determines whether the user of the executing authentication job corresponds to the user who succeeded the authentication. Specially, the authentication unit 136 specifies the authentication job file 142 that is identified by the authentication job identification information included the authentication job information 144 stored the second memory unit 122 from the first memory unit 121. When the individual identification information included the specified authentication job file 142 corresponds to the individual identification information transmitted from the individual identification information acquiring unit 134, the authentication unit 136 determines that the user of the executing authentication job corresponds to the user who succeeds the authentication.

When the user of the executing authentication job doesn't correspond to the user who succeeded the authentication (step S20; NO), the authentication unit 136 moves the process to step S19. When the user of the executing authentication job corresponds to the user who succeeded the authentication (step S20; YES), the authentication unit 136 moves the process to step S21.

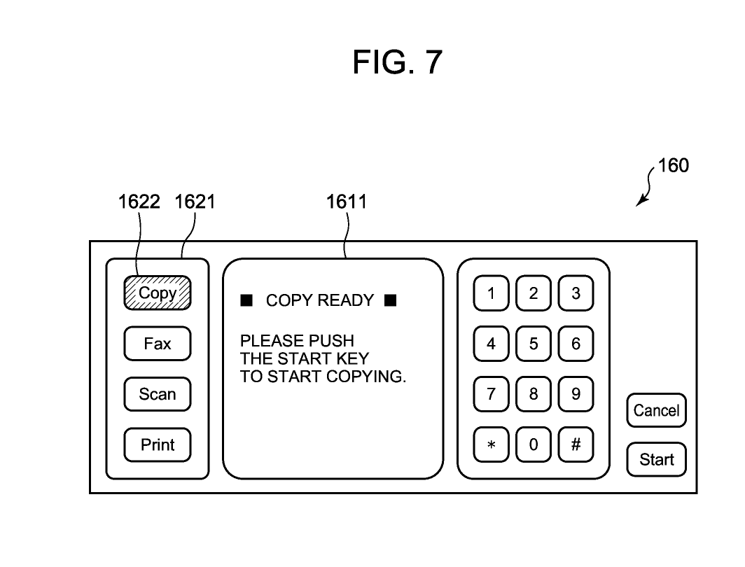

In step S21, the authentication unit 136 controls the image forming apparatus 110 to shift to the login state from the logout state. The authentication unit 136 controls the operation panel control unit 137 to release the lock of the operation panel 160. FIG. 7 shows a screen of the operation panel 160 when the lock of the operation panel 160 is released. As shown FIG. 7, the message “Copy Ready. Please push the Start key to start Copying.” is displayed on the panel display 1611. This message is displayed when the copy key 1622 of the function selecting key 1621 is selected.

As above, when the authentication job corresponding to the user who succeeded the authentication exists (step S15; YES), the image forming apparatus 110 maintains the logout state. Then the image forming apparatus 110 executes the authentication job in the logout state (step S17).

On the other hand, when the image forming apparatus 110 is executing the authentication job corresponding to the user who succeeded the authentication (step S13; YES, step S20; YES), the image forming apparatus 110 shifts from the logout state to the login state (step S21). Namely, while the image forming apparatus 110 is executing the authentication job in the logout state by succeeding the first authentication, the image forming apparatus 110 shifts from the logout state to the login state by succeeding the second authentication. Therefore, the user can make the image forming apparatus 110 execute printing the authentication job and other function concurrently.

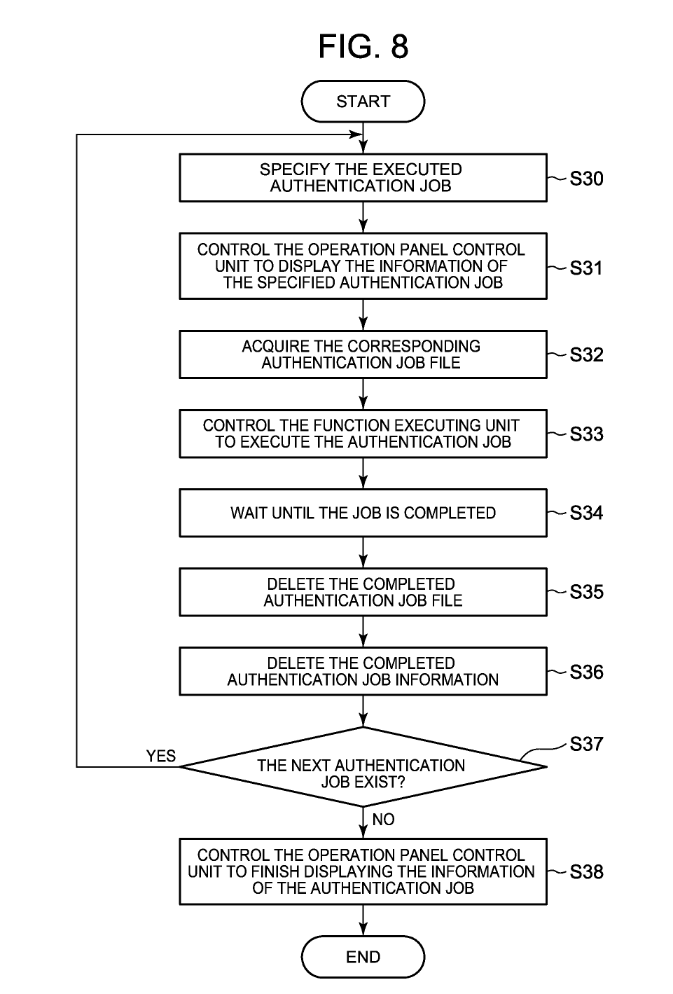

FIG. 8 is a flowchart that shows processing on the authentication job processing unit 138.

The authentication job processing unit 138 starts this flow with reception of an authentication job executing request from the authentication unit 136.

The authentication job processing unit 138 specifies the executed authentication job based on the authentication job information 144 stored the second memory unit 122 (step S30). Specifically, the authentication job processing unit 138 reads the file name of the authentication job file 142 using as the authentication job identification information from the authentication job information 144.

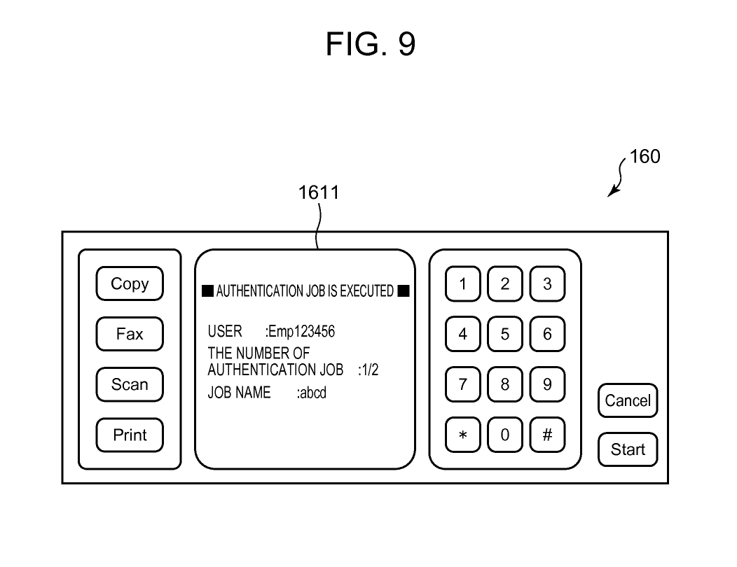

Then the authentication job processing unit 138 controls the operation panel control unit 137 to display information of the specified authentication job on the operation panel 160 (step S31). Specifically, the authentication job processing unit 138 reads the individual identification information and the job name from the authentication job file 142 corresponding to the acquired file name. The authentication job processing unit 138 transmits the instruction for displaying, the individual identification information and the job name to the operation panel control 137. The authentication job processing unit 138 also transmits the number of the authentication job included in the authentication job information 144, namely the number of the record included in the authentication job information 144 to the operation panel control unit 137. The operation panel control unit 137 controls the operation panel 160 to display a message as shown FIG. 9 based on the information acquired from the authentication job processing unit 138. FIG. 9 shows a screen of the operation panel 160 when the image forming apparatus 110 is executing the authentication job. As shown FIG. 9, the individual identification information, namely the user name, the number of the authentication job and the job name are displayed on the panel display unit 1611. The information that displayed on the panel display unit 1611 when the image forming apparatus 110 is executing the authentication is read from the authentication job file 142. The authentication job information 144 stored in the second memory unit 122 may include the information that displayed on the display panel 160.

The authentication job processing unit 138 acquires the authentication job file 142 corresponding to the specified authentication job from the first memory unit 121 (step S32).

The authentication job processing unit 138 controls the function executing unit 150 to execute the processing based on the acquired authentication job file 142 (step S33). Specifically, the authentication job processing unit 138 generates image data based on the acquired authentication job file 142. The authentication job processing unit 138 transmits the generated image data to the function executing unit 150. The authentication job processing unit 138 controls the function executing unit 150 to form image on a sheet such as a paper based on the image data.

The authentication job processing unit 138 waits until the function executing unit 150 completes executing processing (step S34).

After the function executing unit 150 completes executing processing, the authentication job processing unit 138 deletes the authentication job file 142 corresponding to completed processing from the first memory unit 121 (step S35). The authentication job processing unit 138 deletes the record corresponding to the authentication job file 142 from the authentication job information 144 stored in the second memory unit 122 (step S36).

The authentication job processing unit 138 determines whether the authentication job that should be executed next exists based on the authentication job information 144 stored in the second memory unit 122 (step S37). When the authentication job exists (step S37; YES), the authentication job processing unit 138 moves the process to step S30. When the authentication job doesn't exist (step S37; NO), the authentication job processing unit 138 moves the process to step S38.

In step S38, the authentication job processing unit 138 controls the operation panel control unit 137 to delete the information of the specified authentication job from the operation panel 160 (step S38). The authentication job processing unit 138 controls the operation panel control unit 137 to display an original screen on the operation panel 160. Then the authentication job processing unit 138 completes the processing.

According to the first embodiment of the disclosed invention, in the situation that the authentication job was stored in the image forming apparatus 110, when the login authentication succeeds, the image forming apparatus 110 executes the authentication job of the user who succeeds the authentication with maintaining the logout status. Therefore security is enhanced.

According to the first embodiment of the disclosed invention, the user only holds up the IC card and can obtain the executing result of the authentication job. Therefore operation efficiency improves.

According to the first embodiment of the disclosed invention, even if the user want to use other function concurrently during the executing of the authentication job, the image forming apparatus 110 can shift in the login state with executing the authentication job by executing the additional authentication of the same user who instructed the authentication job. Then the image forming apparatus 110 can execute printing the authentication job and the other function concurrently.

In the first embodiment, the function executing unit 150 executes printing based on the authentication job. However, It is not limited.

For example, the first memory unit 121 stores a facsimile data that is acquired by a facsimile communication as the authentication file 142. Then the output of the facsimile data is executed based on the authentication file 142 stored in the first memory unit 121 with maintaining in the logout state by succeeding the authentication of the user who has the authority by using the IC card. In this case, the first memory unit 121 stores the information that indicates the user who has the authority of outputting the facsimile data, in other words, the user who has the authority of executing processing based on the authentication job. The using permission list 141 may include information that indicates the authority of the user.

For example, the first memory unit 121 may store information of contents of the process as the authentication job file 142. The contents of the process are the number of copies, color or monochrome, the size of sheet and the resolution. When the user who has the authority of copy is authenticated by using IC card, in the state that an original document is on a flatbed or in an auto document feeder, the image forming apparatus 110 may execute the copy processing of the document based on the authentication job file 142 in the state of the logout.

The authentication job file 142 may be transmitted from the information processing apparatus 170 to the image forming apparatus 110 whenever the image forming apparatus 110 executes the copy processing. Or the first memory unit 121 may store the authentication job file 142 indicating the contents of default process in advance. The stored authentication job file 142 may be used repeatedly whenever the image forming apparatus 110 executes the copy processing.

Namely, in the first embodiment, when the authentication succeeds in the state that the function executing unit 150 can execute the process, the image forming apparatus doesn't shift to the login state. Then the function executing unit 150 executes the process that the user who succeeds the authentication has the executing authority of. In other words, the operation panel 160 maintains restricting the operation input. Then the function executing unit 150 executes the process that the user who succeeds the authentication has the executing authority of.

In the first embodiment, the authentication is executed by using IC card. However, it may be other authentication methods. For example, it may be biometrics authentication. It may be the input of ID and password. In case that the biometrics authentication is executed, the using permission list 141 needs to include image information for the biometrics authentication. In case that the authentication by inputting of ID and password is executed, the operation panel 160 needs to accept the input of ID and password in the logout state.

In the first embodiment, the image forming apparatus 110 includes the first memory unit 121. However, the first memory unit 121 may be included a file server connected to LAN 180. In case that the image forming apparatus 110 need the information stored in the first memory unit 121, the image forming apparatus 110 may read from the file server through the LAN 180.

In the first embodiment, in shown in step S13 of FIG. 4, when the authentication succeeds, the image forming apparatus 110 determines whether the executing job exists. However the processing may be skipped. In this case, the step S18, S19, S20 of FIG. 4 is skipped.

The first memory unit 121 may be realized by an nonvolatile memory storage device such as the external memory device. The second memory unit 122 may be realized by a volatile memory storage device such as a RAM.

What is claimed is:

1. An image forming apparatus comprising:
a memory configured to store first authentication information;
a function executing unit configured to execute processing;
an acquiring unit configured to acquire second authentication information;
an authentication unit configured to execute authentication of an user by using the first authentication information and the second authentication information;
an operation unit configured to accept operation input;
wherein, when the authentication succeeds and predetermined condition is satisfied, the function executing unit executes the processing with the operation unit restricting the operation input.

2. The image forming apparatus according to claim 1, further comprising;
a job memory configured to store a job about processing to execute;
wherein the function executing unit executes the processing based on the job.

3. The image forming apparatus according to claim 1,
wherein, before the authentication unit executes the authentication, the operation input is restricted by the operation unit;
when the authentication succeeds and the predetermined condition isn't satisfied, the operation unit releases the restriction of the operation input.

4. The image forming apparatus according to claim 2,
wherein, when the authentication succeeds and the function executing unit isn't executing the processing, the authentication unit determines if the predetermined condition is satisfied, based on the job stored in the job memory.

5. The image forming apparatus according to claim 2,
wherein, the predetermined condition is that the job corresponding to the user is stored in the job memory.

6. The image forming apparatus according to claim 5,
wherein, before the authentication unit executes the authentication, the operation input is restricted by the operation unit;
when the authentication succeeds and the function executing unit is executing the processing based on the job corresponding to the user, the operation unit releases the restriction of the operation input even if the predetermined condition is satisfied.

7. The image forming apparatus according to claim 2,
wherein the function executing unit executes image forming processing based on the job.

8. The image forming apparatus according to claim 2, further comprising a job acquiring unit configured to acquire the job and to write the job in the job memory.

9. The image forming apparatus according to claim 2, further comprising a deleting unit configured to delete the job corresponding to processing completed by the function executing unit from the job memory.

10. The image forming apparatus according to claim 1,
wherein the function executing unit includes a scanning unit that scans an image of an original document, and
the predetermined condition is that the original document is set to the scanning unit.

11. An image forming apparatus comprising:
a memory configured to store first authentication information;
a job memory configured to store a job about processing to execute;
a function executing unit configured to execute the processing based on the job;
an acquiring unit configured to acquire second authentication information;
an authentication unit configured to execute authentication of an user by using the first authentication information and the second authentication information;
a control unit configured to execute first processing when the authentication succeeds and the job corresponding to the user is stored in the job memory, and to execute second processing when the authentication succeeds and the job corresponding to the user isn't stored in the job memory.
